(19) United States
(12) Patent Application Publication
(10) Pub. No.: US 2026/0048602 A1
(43) Pub. Date: Feb. 19, 2026

(54) HEAD UNIT

(71) Applicant: FCL COMPONENTS LIMITED, Tokyo (JP)

(72) Inventors: Yuji Yada, Tokyo (JP); Tetsuhiro Ishikawa, Tokyo (JP); Yuuya Ishii, Tokyo (JP); Tatsuya Oguchi, Tokyo (JP)

(21) Appl. No.: 19/280,717

(22) Filed: Jul. 25, 2025

(30) Foreign Application Priority Data
Aug. 19, 2024 (JP) 2024-137492

(51) Int. Cl. B41J 25/304; B41J 2/32

(52) U.S. Cl. CPC B41J 25/304; B41J 2/32

(57) ABSTRACT

A head unit includes a frame, a head assembly detachably supported by the frame, a positioning portion for positioning the head assembly at a first position in a first direction in which a recording medium is conveyed forward, the first direction being a conveyance direction of the recording medium, in a state in which the head assembly is attached, a guide portion for guiding movement of the head assembly to a second position, which is a position farther away from a conveyance path of the recording medium than the first position in a second direction intersecting the first direction and along a thickness direction of the recording medium, and a fulcrum portion at which a posture of the head assembly is changed when the head assembly is moved from the first position to the second position.

### CROSS-REFERENCE TO RELATED APPLICATIONS

Priority is claimed to Japanese Patent Application No. 2024-137492, filed Aug. 19, 2024, the entire content of which is incorporated herein by reference.

### BACKGROUND

A certain aspect of the embodiments is a head unit.

Conventionally, a printer that performs printing by bringing a printing medium into pressure contact with a thermal printer head while conveying the printing medium is known. The printing apparatus of Patent Document 1 includes a thermal printer head assembly having a main body of a thermal printer head and a head support plate to which the main body is fixed, and a head frame to which the thermal printer head assembly is attached. The thermal printer head assembly is provided with a cutout which engages with a guide pin provided on the head frame.

The head frame is provided with a stopper for fixing the head support plate and a lever for releasing the engagement of the thermal printer head assembly. When the printer is used, the head support plate is fixed by the stopper. When the thermal printer head assembly is replaced, the lever is operated to release the fixation of the thermal printer head assembly.

### RELATED ART

[Patent Document 1] Japanese Unexamined Patent Publication No. 2005-324374

### SUMMARY

A head unit of the present disclosure includes a frame, a head assembly including a thermal printer head and detachably supported by the frame, a positioning portion that positions the head assembly at a first position in a first direction in which a recording medium is conveyed forward, the first direction being a conveyance direction of the recording medium, a guide portion that guides movement of the head assembly to a second position that is a position further away from a conveyance path of the recording medium than the first position in a second direction that intersects the first direction and is along a thickness direction of the recording medium, and a fulcrum portion that serves as a fulcrum for changing a posture of the head assembly when the head assembly moves from the first position to the second position.

An object of the present disclosure is to provide a head unit in which a structure for replacing a thermal printer head is simplified.

### BRIEF DESCRIPTION OF THE DRAWINGS

FIG. 1 is a perspective view of a printing apparatus;

FIG. 2 is a perspective view of a main body and a cover, illustrating a state where the cover is closed;

FIG. 3 is a perspective view of a main body and a cover, illustrating a state where the cover is open;

FIG. 4 is a perspective view of the cover;

FIG. 5 is a cross-sectional view of the cover, illustrating a state in which a head assembly is attached to a frame;

FIG. 6 is a cross-sectional view of the cover, illustrating a state in which the head assembly is tilted;

FIG. 7 is a cross-sectional view of the cover, illustrating a state in which the head assembly is further tilted;

FIG. 8 is a cross-sectional view of the cover, illustrating a state in which the head assembly is arranged in a vertical direction;

FIG. 9 is a perspective view of the cover, illustrating a state in which the head assembly is detached;

FIG. 10 is a cross-sectional view of the cover, illustrating a state in which the head assembly is detached;

FIG. 11 is a cross-sectional view of the cover, illustrating a state in which the head-connecting flexible printed circuit (FPC) is inserted into the FPC connecting portion;

FIG. 12 is a cross-sectional view of the cover, illustrating a state in which the head-connecting FPC is not inserted into the FPC connecting portion;

FIG. 13 is a cross-sectional view of the cover, illustrating a state in which a tip portion of a second protrusion of the head cover intersects with a head support plate;

FIG. 14 is a cross-sectional view of the cover, illustrating a state in which the head support plate is tilted and the tip portion of the second protrusion of the head cover is not in contact with the head support plate; and

FIG. 15 is a side view illustrating a side plate of the frame.

### DESCRIPTION OF EMBODIMENTS

In the above-described conventional technique, the structure for replacing the thermal printer head is complicated.

The present disclosure provides a head unit in which a structure for replacing a thermal printer head is simplified.

Hereinafter, a head unit according to an embodiment of the present disclosure will be described. In each drawing, three directions orthogonal to each other, namely an X-axis direction, a Y-axis direction, and a Z-axis direction, may be indicated by arrows. The Z-axis direction is along an up-down direction, for example.

### (Outline of Printing Apparatus)

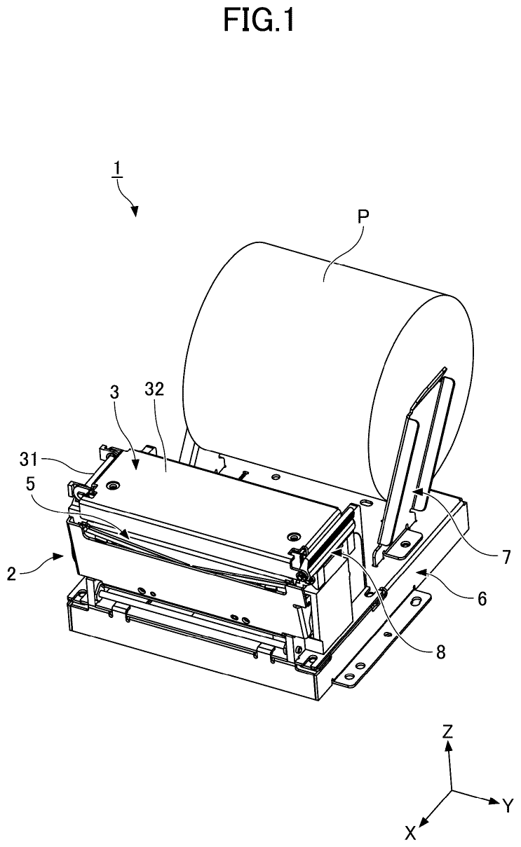

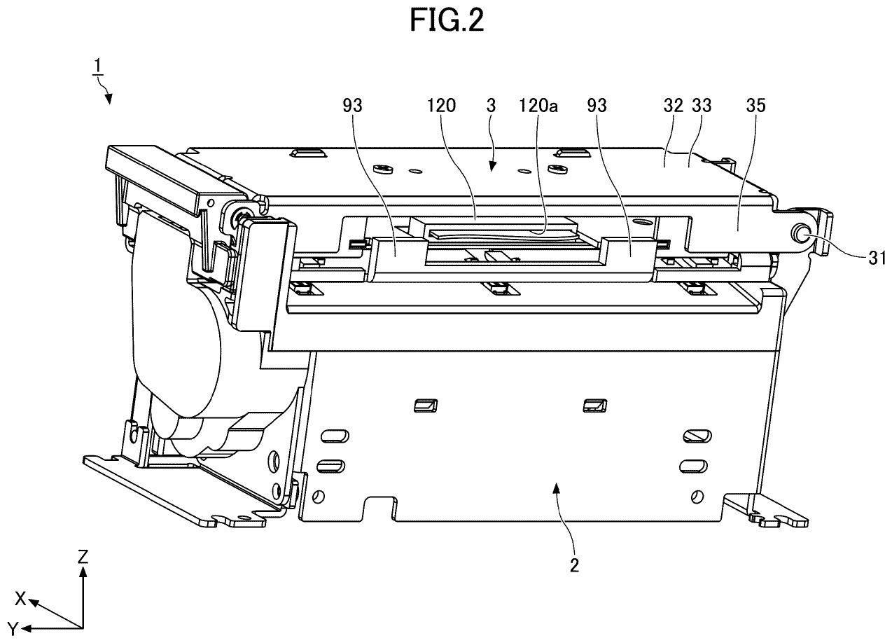

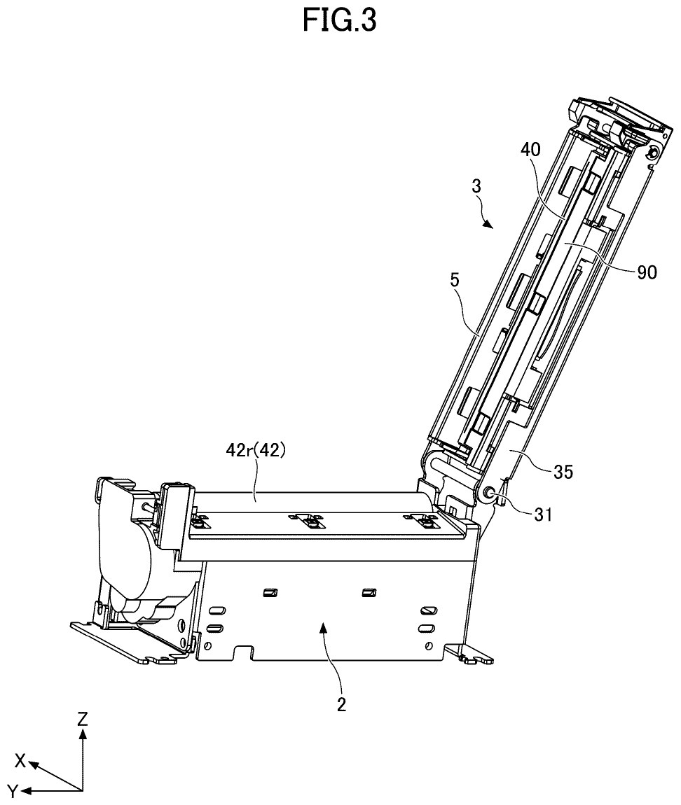

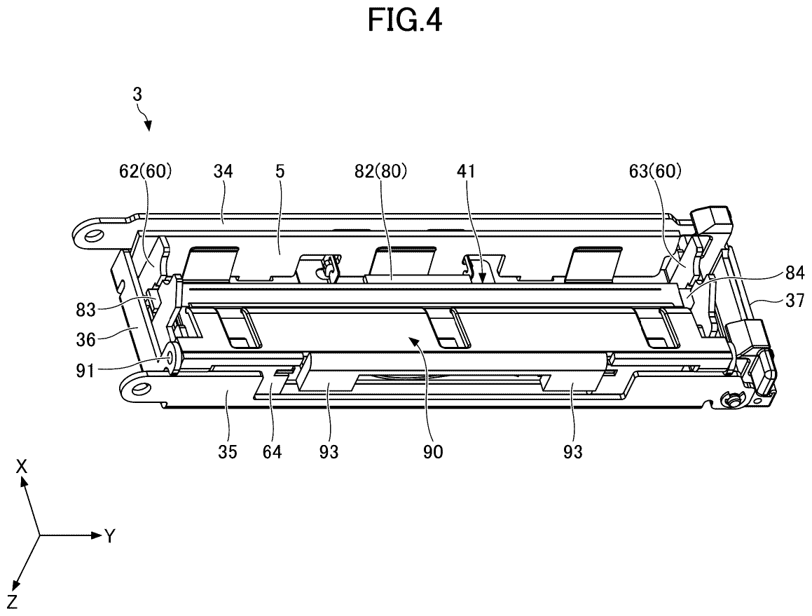

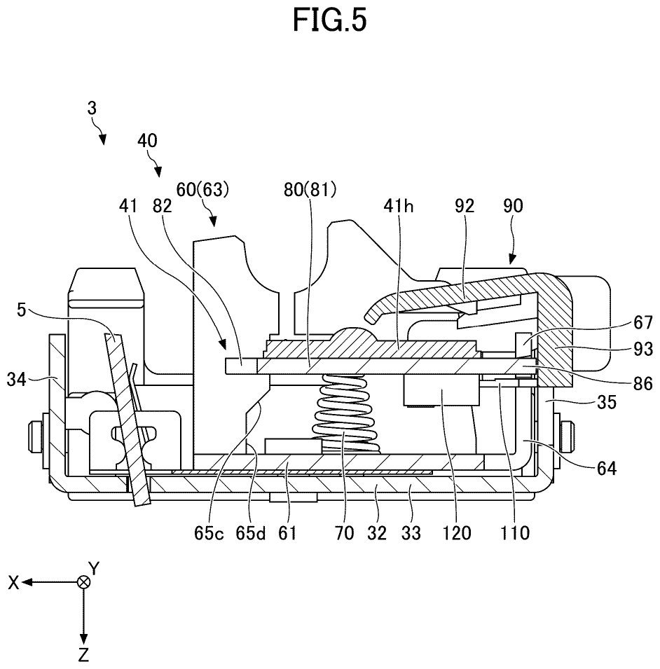

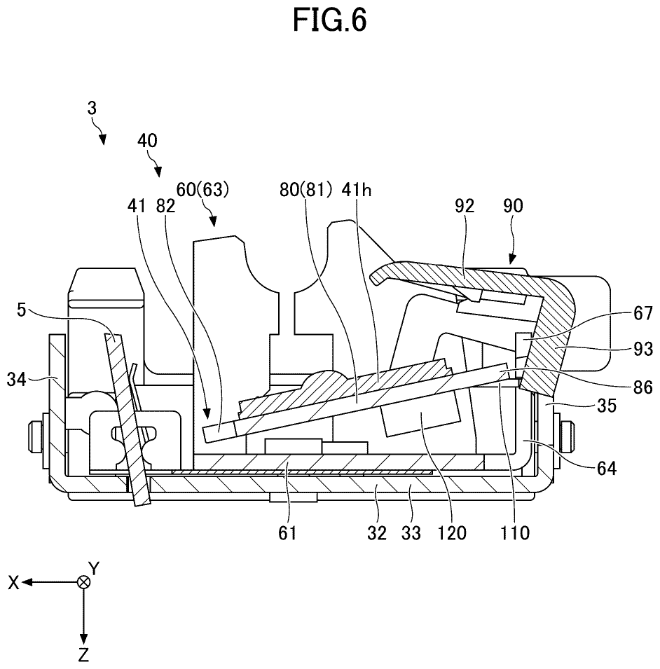

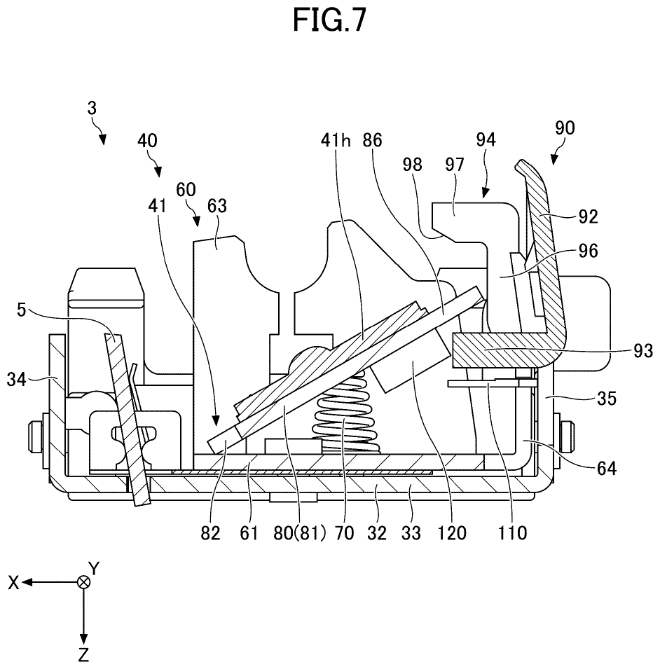

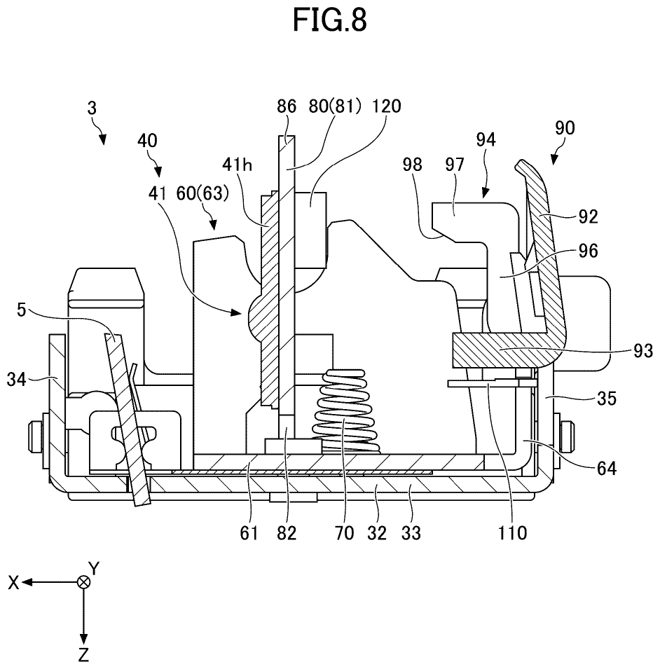

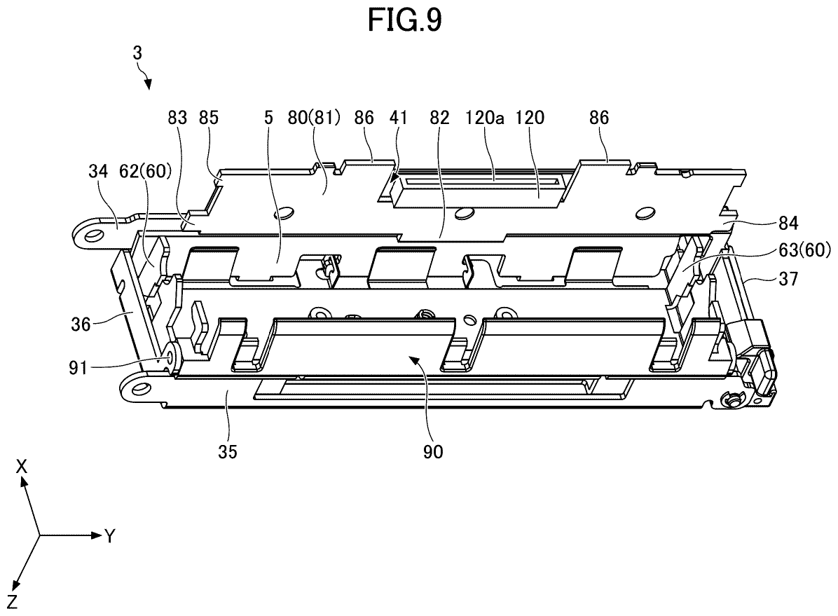

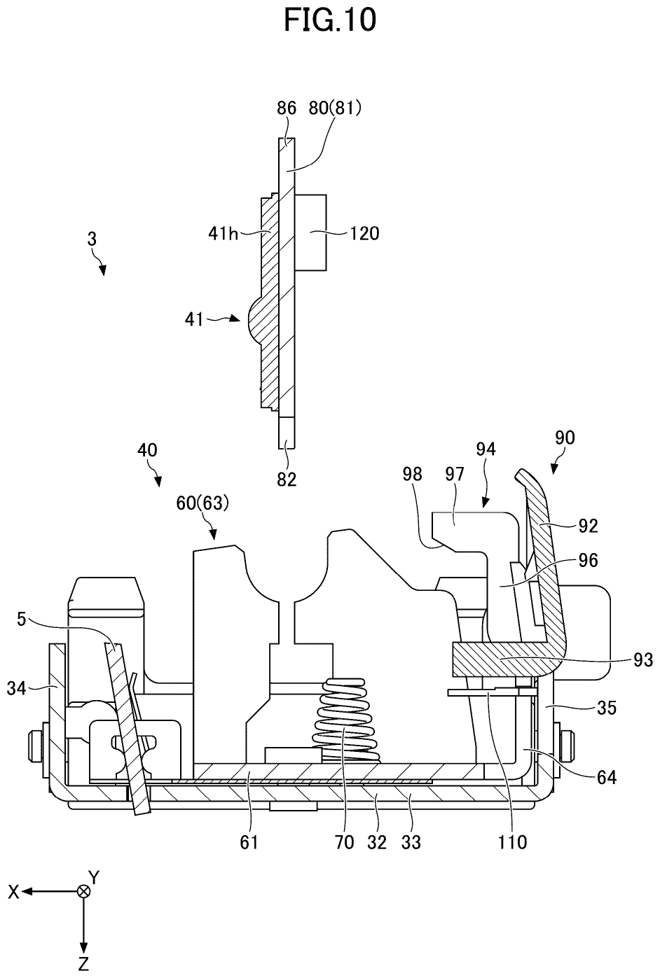

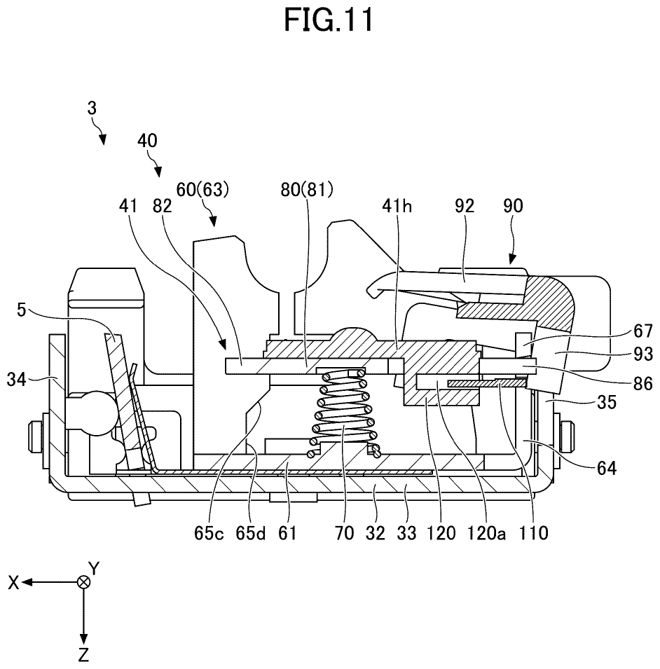

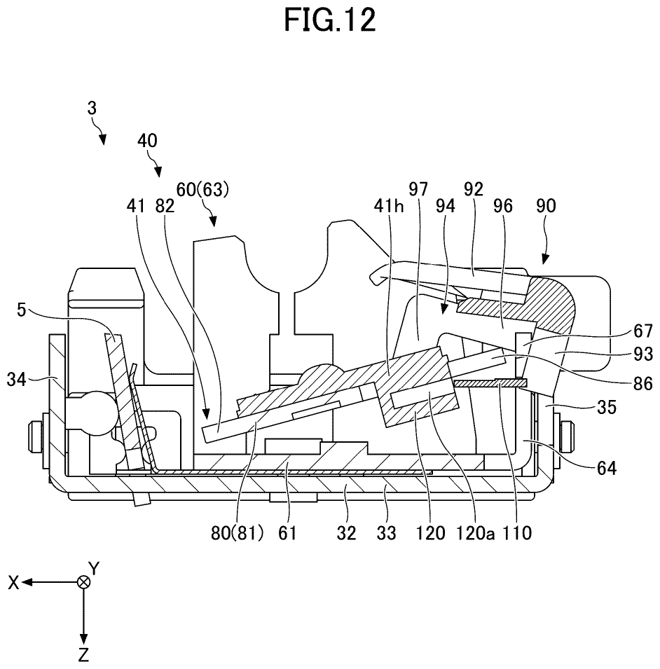

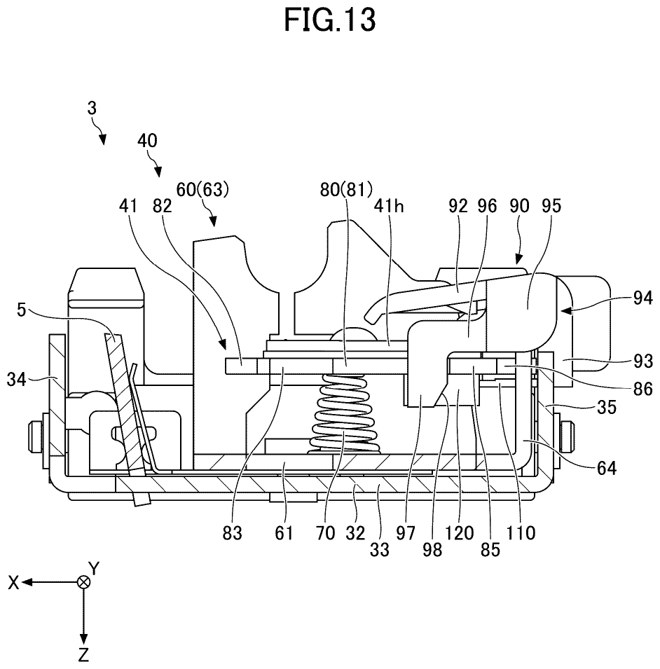

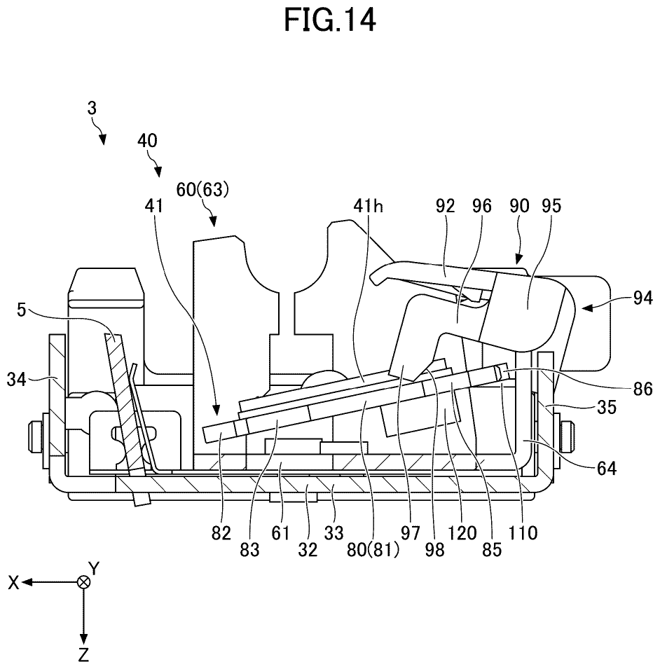

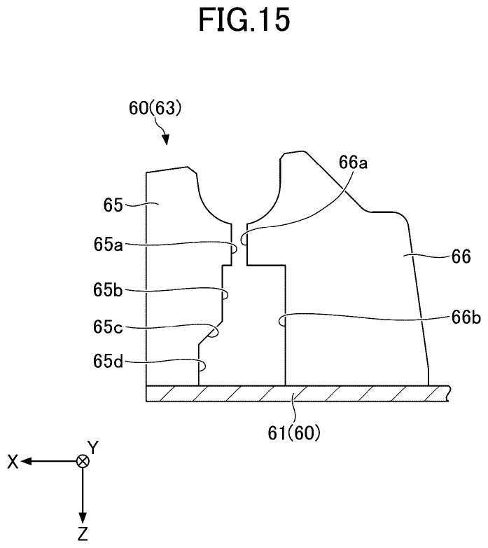

A printing apparatus 1 provided with a head unit 40 will be described. FIG. 1 is a perspective view of the printing apparatus 1. FIG. 2 is a perspective view of a main body 2 and a cover 3, illustrating a state where the cover 3 is closed. FIG. 3 is a perspective view of the main body 2 and the cover 3, illustrating a state where the cover 3 is open. FIG. 4 is a perspective view of the cover 3. FIG. 5 is a cross-sectional view of the cover 3, illustrating a state in which a head assembly 41 is attached to a frame 60. FIG. 6 is a cross-sectional view of the cover 3, illustrating a state in which the head assembly 41 is tilted. FIG. 7 is a cross-sectional view of the cover 3, illustrating a state in which the head assembly 41 is further tilted. FIG. 8 is a cross-sectional view of the cover 3, illustrating a state in which the head assembly 41 is arranged in a vertical direction. FIG. 9 is a perspective view of the cover 3, illustrating a state in which the head assembly 41 is detached. FIG. 10 is a cross-sectional view of the cover 3, illustrating a state in which the head assembly 41 is detached. FIG. 11 is a cross-sectional view of the cover 3, illustrating a state where the head-connecting FPC 110 is inserted into an opening 120a of an FPC connecting portion 120. FIG. 12 is a cross-sectional view of the cover 3, illustrating a state where the head-connecting FPC 110 is not inserted into the opening 120a of the FPC connecting portion 120. FIG. 13 is a cross-sectional view of the cover 3, illustrating a state in which a tip portion 97 of a second protrusion of the head cover 90 intersects a head support plate 80. FIG. 14 is a cross-sectional view of the cover 3, illustrating a state in which the head support plate 80 is tilted and the tip portion 97 of the second protrusion of the head cover 90 is not in contact with (does not intersect) the head support plate 80. FIG. 15 is a side view illustrating a side plate 63 of the frame 60.

The printing apparatus 1 is, for example, a thermal printer including a thermal printer head 41h as illustrated in FIG. 5, and is used in multimedia stations (MMSs) installed in convenience stores, automatic teller machines (ATMs), cash dispensers (CDs), ticket issuing machines, registers, or the like. The printing apparatus 1 conveys a recording paper P (see FIG. 1) which is thermal paper, prints information such as characters or numerals on the recording paper P, and cuts the printed recording paper P, thereby outputting a piece of recording paper such as a ticket or a receipt.

As illustrated in FIG. 1, the printing apparatus 1 includes a main body 2, a cover 3, a cutter blade 5, a base 6, and a recording paper holder 7.

The cover 3 is provided, for example, on the main body 2 in the side where the recording paper P is inserted, in an openable and closable manner. In FIG. 2, the cover 3 provided on the main body 2 is in a fully closed state, and in FIG. 3, the cover 3 is in a fully opened state. The cover 3 has, for example, a rectangular planar shape having a longitudinal direction corresponding to a width direction of the recording paper P, which is roll paper. The cover 3 is rotatable about a rotation shaft 31 arranged in the X-axis direction.

As illustrated in FIG. 3, the printing apparatus 1 includes a head unit 40 and a platen unit 42. The head unit 40 includes the thermal printer head 41h (see FIG. 5) that performs printing on the recording paper P. The platen unit 42 includes a platen roller 42r that conveys the recording paper P. In the printing apparatus 1, the head unit 40 is mounted in the cover 3, and the platen unit 42 is mounted in the main body 2. The head unit 40 may be provided in the main body 2, and the platen unit 42 may be provided in the cover 3.

The main body 2 is provided with a conveyance drive system including a motor and gears for rotating the platen roller 42r. The printing apparatus 1 performs printing with the thermal printer head 41h while conveying the recording paper P inserted between the platen roller 42r and the thermal printer head 41h.

The cutter blade 5 for cutting the recording paper P after printing is situated in the main body 2 and the cover 3 (see FIGS. 1 and 5).

The base 6 is, for example, a rectangular plate-shaped member serving as a pedestal of the printing apparatus 1 as illustrated in FIG. 1. The main body 2 and the recording paper holder 7 are arranged adjacent to each other on the base 6. The recording paper holder 7 rotatably supports the recording paper P, which is roll paper, for example.

### (Cover)

As illustrated in FIGS. 2 to 4, the cover 3 includes a cover main body 32 and the head unit 40. The cover main body 32 includes a top plate 33, a front plate 34, and a rear plate 35. The plate thickness direction of the top plate 33 is along the Z-axis direction. The front plate 34 and the rear plate 35 are bent, from both end portions of the top plate 33 in the X-axis direction, and extend in the Z-axis direction. The plate thickness direction of the front plate 34 and the rear plate 35 is along the X-axis direction. The terms “X-axis direction”, “Y-axis direction”, and “Z-axis direction” used in the description of the cover 3 refer to the X-axis direction, the Y-axis direction, and the Z-axis direction in a situation where the cover 3 is closed as illustrated in FIG. 1. As for the terms “front” and “rear” used hereinafter, “front” refers to the downstream of the conveyance direction of the recording paper and “rear” refers to the upstream of the same.

As illustrated in FIG. 4, the cover 3 has a side plate 36 and a side plate 37 that face each other in the Y-axis direction. The side plate 36 and the side plate 37 are bent, from both end portions of the top plate 33 in the Y-axis direction, and extend in the Z-axis direction. The plate thickness direction of the side plate 36 and the side plate 37 is along the Y-axis direction.

### (Head Unit)

The head unit 40 includes, for example, the frame 60, a spring 70, the head assembly 41, and the head cover 90, as illustrated in FIG. 5. The head assembly 41 includes the thermal printer head 41h and the head support plate 80.

### (Frame)

As illustrated in FIGS. 4 and 5, the frame 60 includes a main body plate 61, a side plate 62, a side plate 63, and a back plate 64. The plate thickness direction of the main body plate 61 is along the Z-axis direction. The side plate 62 and the side plate 63 are arranged apart from each other in the Y-axis direction. The side plate 62 and the side plate 63 are bent, from both end portions of the main body plate 61 in the Y-axis direction, and extend in the Z-axis direction. The plate thickness direction of the side plate 62 and the side plate 63 is along the Y-axis direction. The back plate 64 is bent from the front end of the main body plate 61 and extends in the Z-axis direction. The plate thickness direction of the back plate 64 is along the X-axis direction.

The frame 60 is attached to the inside of the cover 3. Specifically, the main body plate 61 of the frame 60 is attached to the inner surface of the top plate 33 of the cover 3. The frame 60 may be attached to the cover 3 via another member. The main body plate 61 is arranged to face the top plate 33 in the Z-axis direction. The back plate 64 is arranged to face the rear plate 35 in the X-axis direction.

In the side plate 62 and the side plate 63, a guide shape for inserting the head support plate 80 is respectively formed. The guide shapes provided on the side plate 62 and the side plate 63 will be described later.

### (Spring)

The spring 70 is attached to the main body plate 61 of the frame 60, for example, as illustrated in FIG. 5. The spring 70 is arranged between the main body plate 61 and the head assembly 41 in the Z-axis direction. The spring 70 presses the head assembly 41 against the recording paper P. The spring 70 is, for example, a compression coil spring. In the spring 70, a side closer to the main body plate 61 is referred to as a “base end side”, and a side closer to the head assembly 41 is referred to as a “distal end side”. The inner diameter of the compression coil spring on the distal end side is smaller than the inner diameter thereof on the base end side.

The spring 70 may press the thermal printer head 41h via the head support plate 80 that supports the thermal printer head 41h. The spring 70 serves as a fulcrum when the head assembly 41 is tilted when the head assembly 41 is replaced. Details will be described later. The replacement of the head assembly 41 includes attachment and detachment of the head assembly 41. The plurality of springs 70 are arranged at predetermined intervals in the Y-axis direction. The spring 70 is an example of a fulcrum portion. The fulcrum portion is not limited to the compression coil spring, and may be, for example, another biasing member, and the biasing member may be, for example, a plate spring.

### (Thermal Printer Head)

The thermal printer head 41h includes, for example, a substrate, a heating element, a driver IC, and the FPC connecting portion 120. As illustrated in FIGS. 10 and 11, the FPC connecting portion 120 is provided on the rear surface side of the head assembly 41 and is connected to the head-connecting FPC 110. In the FPC connecting portion 120, an opening 120a into which the head-connecting FPC 110 is inserted is formed. The back surface of the head assembly 41 is a surface on the side opposite to the side on which the platen unit 42 is located.

### (Head Support Plate)

The head support plate 80 is formed in a plate shape as illustrated in FIG. 5, for example, and supports the thermal printer head 41h. The head support plate 80 has a higher rigidity than the thermal printer head 41h, and can suppress deformation of the thermal printer head 41h. The thermal printer head 41h is attached to the head support plate 80. The thermal printer head 41h is attached to the surface of the head support plate 80 on the side opposite to the side on which the spring 70 is located.

The area of the head support plate 80 may be larger than that of the thermal printer head 41h. The head support plate 80 includes a main body 81 and an overhanging portion 82. The main body 81 may be a portion on which the thermal printer head 41h is stacked. The overhanging portion 82 protrudes from the main body 81 in the X-axis direction. The overhanging portion 82 may be formed in the center portion of the head support plate 80 in the Y-axis direction. The overhanging portion 82 projects forward in the X-axis direction. When a user detaches the head assembly 41 from the frame 60, the user can change the posture of the head assembly 41 by pushing the overhanging portion 82.

As illustrated in FIG. 4, the head support plate 80 has a pair of projecting portions 83 and 84. The pair of projecting portions 83 and 84 protrude from the main body portion 81 in the Y-axis direction. The projecting portions 83 and 84 are a portion to be inserted into a gap between a wall surface 65a (see FIG. 15) and a wall surface 66a (see FIG. 15), which are described later. The projecting portions 83 and 84 protrude outward from the side plates 62 and 63 in the Y-axis direction. The projecting portions 83 and 84 have a predetermined length in the X-axis direction.

As illustrated in FIGS. 9 and 13, the head support plate 80 has a projecting portion 85. The projecting portion 85 projects in the same direction as the projecting portion 83. The projecting portion 83 and the projecting portion 85 are arranged apart from each other in the X-axis direction. The projecting portion 85 is arranged closer to the back plate 64 of the frame 60 than the projecting portion 83. A recess is formed between the projecting portion 83 and the projecting portion 85. As illustrated in FIG. 13, a tip portion 97 of a second protrusion 94, which will be described later, of the head cover 90 can be inserted into the recess between the projecting portion 83 and the projecting portion 85. The length of the projecting portion 85 in the Y-axis direction is shorter than that of the projecting portion 83. The projecting portion 83 is formed to overhang outward beyond the side plate 62, and the projecting portion 85 has a length that does not allow the projecting portion 85 to come into contact with the side plate 62.

As illustrated in FIG. 5, the head support plate 80 has overhanging portions 86. The overhanging portions 86 overhang on the side opposite to the side on which the overhanging portion 82 overhangs in the X-axis direction. In the state illustrated in FIG. 9, the overhanging portions 86 overhang on the side opposite to the side on which the overhanging portion 82 overhangs in the Z-axis direction. In the state illustrated in FIG. 5, the overhanging portions 86 are locked to the back plate 64 of the frame 60. The back plate 64 is provided with a locking portion 67 to which the overhanging portion 86 is locked. The locking portion 67 may be a locking claw, or may be an opening or a recess into which the overhanging portion 86 can be inserted. The overhanging portion 86 is an example of a second overhanging portion.

### (Head Cover)

The head cover 90 is formed to cover a part of the thermal printer head 41h. The head cover 90 is supported by the pair of side plates 36 and 37 of the cover 3. The head cover 90 is provided with pins 91 protruding in the Y-axis direction. The pins 91 are inserted into holes provided in the side plates 36 and 37. The axial direction of the pins 91 is along the Y-axis direction. The head cover 90 is swingable about the pins 91. The head cover 90 can protect terminals formed on the thermal printer head 41h, for example. FIGS. 4 and 5 illustrate a state in which the head cover 90 is closed. In a use state of the printing apparatus 1, the head cover 90 is closed as illustrated in FIGS. 4 and 5. When the head assembly 41 is replaced, the head cover 90 is in an open state as illustrated in FIG. 9.

The head cover 90 includes a cover main body 92 and first protrusions 93 as illustrated in FIG. 5. The cover main body 92 is formed to cover a part of the thermal printer head 41h. In a state where the head cover 90 is closed, the plate thickness direction of the cover main body 92 is substantially along the Z-axis direction. The plate thickness direction of the cover main body 92 may be tilted with respect to the Z-axis direction. In other words, the surface of the cover main body 92 may be tilted with respect to the XY plane. The cover main body 92 extends from a position corresponding to the rear plate 35 toward the front plate 34 in the X-axis direction. The cover main body 92 is formed so as to cover approximately half of the thermal printer head 41h in the X-axis direction.

As illustrated in FIG. 4, the first protrusions 93 are formed so as to protrude in the Z-axis direction from the end portion on the rear side of the cover main body 92. When the head assembly 41 is attached, the head support plate 80 contacts the first protrusions 93, and the first protrusions 93 can cause the head cover 90 to swing, and can thereby close the head cover 90 as illustrated in FIG. 5. The first protrusions 93 are arranged apart from each other in the Y-axis direction. An opening is formed between the first protrusions 93. In a normal state in which printing on the recording paper P can be performed, the overhanging portions 86 of the head support plate 80 may be in contact with the first protrusions 93.

As illustrated in FIG. 13, the head cover 90 has the second protrusion 94. The second protrusion 94 includes a first portion 95 extending from the cover main body 92 in the Z-axis direction, a second portion 96 extending from the first portion 95 in the X-axis direction, and the tip portion 97 extending from the second portion 96 in the Z-axis direction. In the state where the head cover 90 is closed, the tip portion 97 is arranged in the recess between the projecting portion 83 and the projecting portion 85 as described above. When the head assembly 41 is attached to the frame 60, the tip portion 97 abuts against the projecting portion 85 of the head support plate 80, and the head support plate 80 can be thereby moved rearward.

The tip portion 97 has a predetermined thickness. The plate thickness direction of the tip portion 97 is along the Y-axis direction. In the tip portion 97, a tilted portion 98 which can be brought into contact with the projecting portion 85 is formed. In the X-axis direction, the width of the distal end side of the distal end portion 97 is narrower than the width of the base end side of the distal end portion 97. The tilted portion 98 is tilted with respect to the X-axis and the Z-axis when viewed in the Y-axis direction. The tilted portion 98 is not limited to a linearly formed portion when viewed in the Y-axis direction, and may be formed in a curved shape.

In a state where the head cover 90 is closed, the tilted portion 98 is arranged at a position closer to the top plate 33 of the cover 3 than the head support plate 80. In a state where the head cover 90 is closed, the tip portion 97 is arranged on the rear side of the spring 70.

### (Head-Connecting FPC)

As illustrated in FIGS. 10 and 11, the head-connecting FPC 110 is placed so as to extend forward in the X-axis direction from the back plate 64 of the frame 60. The plate thickness direction of the head-connecting FPC 110 is along the Z-axis direction. As described above, the head-connecting FPC 110 is inserted into the opening 120a of the FPC connecting portion 120.

### (Guide Shape of Frame)

As illustrated in FIG. 15, the side plate 63 of the frame 60 includes a first portion 65 and a second portion 66. The side plate 62 has the same shape as the side plate 63. The first portion 65 and the second portion 66 are arranged apart from each other in the X-axis direction. The first portion 65 and the second portion 66 may be connected to each other.

A guide groove into which a projecting portion 84 of the head support plate 80 is inserted when the head assembly 41 is replaced is formed between the first portion 65 and the second portion 66.

The first portion 65 has wall surfaces 65a, 65b, 65c, and 65d. The wall surfaces 65a, 65b, 65c, and 65d are formed in this order, in the Z-axis direction, and the wall surface 65d is arranged at a position closest to the main body plate 61. The wall surfaces 65a, 65b, and 65d may be surfaces parallel to the YZ plane. In the present disclosure, being “parallel” includes being substantially parallel. The wall surface 65c is tilted with respect to the X-axis and the Z-axis when viewed in the Y-axis direction. The wall surface 65a is arranged at a position closer to the second portion 66 than the wall surfaces 65b, 65c, and 65d in the X-axis direction. The wall surface 65d is arranged at a position farther away from the second portion 66 than the wall surfaces 65a, 65b, and 65c, in the X-axis direction.

The second portion 66 has wall surfaces 66a and 66b. The wall surface 66a is arranged to face the wall surface 65a in the X-axis direction. The wall surface 66b is arranged closer to the main body plate 61 than the wall surface 66a, in the Z-axis direction. The wall surface 66b is arranged to face the wall surfaces 65b, 65c, and 65d in the X-axis direction. The wall surfaces 66a and 66b may be surfaces parallel to the YZ plane.

The distance between the wall surface 65a and the wall surface 66a in the X-axis direction corresponds to the plate thickness of the projecting portion 84. The gap between the wall surface 65a and the wall surface 66a has a size through which the projecting portion 84 can pass in a state where the projecting portion 84 is arranged in such a manner that the plate thickness direction thereof is along the X-axis direction.

The distance between the wall surface 65b and the wall surface 66b in the X-axis direction corresponds to the width of the projecting portion 84. The width of the projecting portion 84 may be the same as the width of the projecting portion 83 illustrated in FIG. 13. In a state where the head assembly 41 is attached to the frame 60, the projecting portion 84 is arranged between the wall surface 65b and the wall surface 66b.

The edge of the wall surface 65c that is closer to the wall surface 65d is arranged farther away from the wall surface 66b in the X-axis direction than the edge of the wall surface 65b that is closer to the wall surface 65c. The wall surface 65c functions as a guide surface that guides the movement of the projecting portion 84 of the head support plate 80 when the head assembly 41 is detached from the frame 60. The front end portion of the projecting portion 84 moves forward along the wall surface 65c and moves in a direction of approaching the main body plate 61. At this time, the head support plate 80 is tilted as described later.

### (Detachment of Head Assembly)

Next, the operation for detaching the head assembly 41 will be described. In the description of the operation of detaching and attaching the head assembly 41, the terms “upper” and “lower” are used, and these terms are used in accordance with the state illustrated in each drawing. In the Z-axis direction, a side closer to the main body plate 61 is referred to as “lower”, and a side farther from the main body plate 61 is referred to as “upper”. In the state illustrated in FIG. 5, the head support plate 80 is arranged below the thermal printer head 41h.

The thermal printer head 41h and the head support plate 80 move integrally as the head assembly 41. First, a state in which the head assembly 41 is attached to the frame 60 is illustrated in FIG. 5. At this time, the head support plate 80 is supported by the spring 70. The projecting portion 83 is fitted in an opening between the wall surface 65b and the wall surface 66b of the side plate 62. The projecting portion 84 is fitted in an opening between the wall surface 65b and the wall surface 66b of the side plate 63.

When the head assembly 41 is detached, the posture of the head assembly 41 is changed as illustrated in FIGS. 5 to 8. A user can release a fixed state of the head support plate 80 by pushing the overhanging portion 82, and can tilt the head assembly 41 as illustrated in FIG. 6. At this time, the projecting portions 83 and 84 move downward and forward while touching the wall surface 65c.

By being pushed at the overhanging portion 82 from above, the head support plate 80 is tilted at a point where the head support plate 80 is in contact with the spring 70 as a fulcrum. The overhanging portion 82 is lowered and the end of the head support plate 80 that is closer to the back plate 64 is raised. At this time, as illustrated in FIG. 12, the connection between the FPC connecting portion 120 and the head-connecting FPC 110 is disengaged. In this state, the head-connecting FPC 110 is out of the opening 120a of the FPC connecting portion 120.

As illustrated in FIG. 7, the overhanging portion 82 moves until it abuts against the main body plate 61. At this time, the overhanging portion 86 is arranged above the back plate 64 and is not in contact with the back plate 64.

As illustrated in FIG. 8, a user can set the head support plate 80 to be in a standing state along the Z-axis direction. At this time, the head support plate 80 is arranged in such a manner that the plate thickness direction thereof is along the X-axis direction. The projecting portion 83 and the projecting portion 84 are arranged below the gap between the wall surface 65a and the wall surface 66a.

By pulling up the head assembly 41 from the state illustrated in FIG. 8, the head assembly 41 can be detached from the frame 60 as illustrated in FIGS. 9 and 10. At this time, the projecting portion 83 and the projecting portion 84 pass through the gap between the wall surface 65a and the wall surface 66a and are pulled up.

### (Attachment of Head Assembly)

Next, the operation for attaching the head assembly 41 will be described. As illustrated in FIGS. 9 and 10, the head assembly 41 is erected, the overhanging portion 82 is arranged in a downward direction, the overhanging portion 86 is arranged in an upward direction, and then the projecting portion 83 and the projecting portion 84 are inserted into the gap between the wall surface 65a and the wall surface 66a.

As illustrated in FIG. 8, the head support plate 80 is pushed downward, whereby the overhanging portion 82 is pushed against the main body plate 61. As illustrated in FIG. 7, the head assembly 41 can be tilted by inclining the overhanging portion 86 rearward. The overhanging portion 82 is moved forward in the state illustrated in FIG. 7 compared to the state illustrated in FIG. 8. The overhanging portion 82 abuts against the upper surface of the main body plate 61, and the distal end of the spring 70 abuts against the head support plate 80.

As illustrated in FIG. 6, the posture of the head support plate 80 can be changed with the spring 70 as a fulcrum by moving the overhanging portion 86 downward. At this time, the projecting portion 83 and the projecting portion 84 abut against the wall surface 65c of the wall surface, and the movement of the head support plate 80 is guided. The posture of the head support plate 80 changes in such a manner that the plate thickness direction of the head support plate 80 approaches or becomes closer to the Z-axis direction. At this time, by closing the head cover 90, the tip portion 97 of the second protrusion 94 of the head cover 90 is inserted between the projecting portion 83 and the projecting portion 85. When the tip portion 97 further moves downward, the tip portion 97 abuts against the projecting portion 85, and the projecting portion 85 moves rearward. The head support plate 80 is moved rearward, and the plate thickness direction of the head support plate 80 is arranged so as to be along the Z-axis direction.

As illustrated in FIG. 12, the head-connecting FPC 110 existing rearward from the opening 120a of the FPC connecting portion 120 is inserted into the opening 120a as illustrated in FIG. 11. The projecting portion 83 and the projecting portion 84 abut against the wall surface 65c and are thereby guided, and then fit in a gap between the wall surface 65b and the wall surface 66b. Thus, the head assembly 41 is positioned as illustrated in FIG. 5. In this state, the projecting portion 85 is locked to the locking portion 67 of the back plate 64.

### (Operations and Effects of Head Unit According to Embodiment)

The head unit 40 according to the embodiment includes: the frame 60; the head assembly 41 detachably supported by the frame 60 and including the thermal printer head 41h; the wall surfaces 65b and 66b serving as a positioning portion for positioning the head assembly 41 at a first position in the X-axis direction (first direction) which is a conveyance direction of the recording paper P; the wall surface 65c serving as a guide portion for guiding the head assembly 41 to a second position (lower position) which is farther from a conveyance path of the recording paper P than the first position in the Z-axis direction (second direction), the Z-axis direction intersecting the X-axis direction and being along a thickness direction of the recording paper P; and the spring (fulcrum portion) 70 that serves as a fulcrum at which the posture of the head assembly 41 is changed when the head assembly 41 is moved from the first position illustrated in FIG. 5 to the second position illustrated in FIG. 7.

According to the head unit 40, the head assembly 41 can be detached from the frame 60 after the head assembly 41 is tilted by moving the head assembly 41 along the wall surface 65c. The structure for detaching the head assembly 41 from the frame 60 can be simplified. A lever or the like as in the conventional technique can be eliminated.

The head assembly 41 includes the thermal printer head 41h and the head support plate 80. The head support plate 80 supports the thermal printer head 41h, is arranged on the opposite side of the thermal head 41h to the conveyance path, in the Z-axis direction, in the Z-axis direction, and is movable integrally with the thermal printer head 41h. The fulcrum portion includes the spring (biasing member) 70 that biases the head support plate 80 to be close to the conveyance path. The head support plate 80 has an overhanging portion (first overhanging portion) 82 that overhangs at a first position in the X-axis direction up to a position where the overhanging portion does not overlap the thermal printer head 41h. The wall surfaces 65b and 66b serving as the positioning portion come into contact with the head support plate 80 so as to position the head support plate 80 at the first position. The wall surface 65c serving as the guide portion comes into contact with the head support plate 80 so as to guide movement of the head support plate 80 and guide, in turn, movement of the head assembly 41. The spring 70 is in contact with the head support plate 80 when the head assembly 41 moves from the first position to the second position, and the posture of the head assembly 41 is changed with respect to the spring 70 as a fulcrum by the overhanging portion 82 being pushed in a direction away from the conveyance path in the Z-axis direction.

According to the head unit 40 having this configuration, the posture of the thermal printer head 41h can be changed by moving the head support plate 80 overlapping with the thermal printer head 41h while abutting against the wall surface 65c serving as the guide portion, and the thermal printer head 41h can be thereby detached from the frame 60.

The frame 60 includes a main body plate 61 arranged on the opposite side of the thermal head 41h to the conveyance path, in the Z-axis direction, and a pair of side plates 62 and 63 arranged apart from each other in the Y-axis direction (third direction) along the width direction of the recording paper P and protruding from the main body plate 61 in the Z-axis direction. The pair of side plates 62 and 63 are provided with the wall surfaces 65b and 66b as a positioning portion and the wall surface 65c as a guide portion.

According to the head unit 40 having this configuration, positioning of the head assembly 41 can be performed by bringing the head support plate 80 into contact with the wall surfaces 65b and 66b formed on the pair of side plates 62 and 63. According to the head unit 40 having this configuration, the thermal printer head 41h can be replaced by moving the head assembly 41 while the head support plate 80 abuts against the wall surface 65c formed on the pair of side plates 62 and 63.

The head unit 40 further includes the head cover 90 connected to the frame 60 and swingable about the pin (rotation axis) 91 extending in the Y-axis direction. The head cover 90 includes the cover main body (main body plate) 92 for covering the thermal printer head 41h and the first protrusion 93 projecting in the Z-axis direction (thickness direction of the thermal printer head 41h) with the cover main body 92 covering the thermal printer head 41h. The head support plate 80 including the overhanging portion (second overhanging portion) 86 overhanging on the side opposite to the side on which the overhanging portion 82 overhangs in the X-axis direction. The head assembly 41 is positioned at the first position. In a state where the cover main body 92 covers the thermal printer head 41h, the overhanging portion 86 contacts the first projecting portion 93, and in a state where the head support plate 80 is in contact with the wall surface 65c serving a guide portion, a gap is formed between the first projecting portion 93 and the overhanging portion 86. In this state, the first protrusion 93 is not in contact with the overhanging portion 86.

According to the head unit 40 having this configuration, when the head assembly 41 is attached to the frame 60, the overhanging portion 86 can be moved in the X-axis direction until the overhanging portion 86 of the head support plate 80 abuts against the first protrusion 93 of the head cover 90.

In the head unit 40, the head cover 90 includes the tip portion 97 of the second protrusion 94 which is arranged at a position separated from the first protrusion 93 and protrudes from the pin 91 in the same direction as the first protrusion 93, and the tip portion 97 of the second protrusion 94 is contactable to the head support plate 80 at a position closer to the pin 91 than the position at which the spring 70 and the head support plate 80 come into contact with each other in the X-axis direction. Specifically, the tip portion 97 is contactable to the projecting portion 85 arranged rearward of the spring 70.

According to the head unit 40 having this configuration, the head support plate 80 can be moved rearward by pressing the tip portion 97 of the second protrusion 94 against the head support plate 80, and the thermal printer head 41h can be moved rearward when the head assembly 41 is attached.

In the head unit 40, the spring 70 is arranged rearward of the wall surface 65c, which is the guide portion, in the X-axis direction. When the thermal printer head 41h is replaced, the posture of the head support plate 80 can be changed by tilting the head support plate 80 with the spring 70 arranged rearward of the wall surface 65c as a fulcrum. After the head support plate 80 is tilted, the head assembly 41 can be detached from the frame 60.

In the head unit 40, the thermal printer head 41h includes the FPC connecting portion 120 connectable to the flexible substrate, and the FPC connecting portion 120 is arranged rearward of the spring 70 in the X-axis direction. The FPC connecting portion 120 is arranged at a position closer to the overhanging portion 86 than to the overhanging portion 82 in the X-axis direction. According to the head unit 40 having this configuration, the FPC connecting portion 120 and the head-connecting FPC 110 can be connected by moving the head support plate 80 rearward, and the connection between the FPC connecting portion 120 and the head-connecting FPC 110 can be disengaged by moving the head support plate 80 forward.

The head support plate 80 includes the overhanging portion (second overhanging portion) 86 that overhangs on the side opposite to the side on which the overhanging portion (first overhanging portion) 82 overhangs in the X-axis direction. The frame 60 has the locking portion 67 to which the overhanging portion (second overhanging portion) 86 is locked.

According to the head unit 40 having this configuration, in a normal state in which printing can be performed, the head support plate 80 can be locked to the locking portion 67 formed in the frame 60.

The configurations described in the above embodiment are merely examples of the contents of the present invention, and may be combined with other known techniques, and a part of the configurations may be omitted or changed without departing from the scope of the present invention.

What is claimed is:

1. A head unit, comprising:
a frame;
a head assembly including a thermal printer head and detachably supported by the frame;
a positioning portion that positions the head assembly at a first position in a first direction in which a recording medium is conveyed forward, the first direction being a conveyance direction of the recording medium;
a guide portion that guides movement of the head assembly to a second position that is a position further away from a conveyance path of the recording medium than the first position in a second direction that intersects the first direction and is along a thickness direction of the recording medium; and
a fulcrum portion that serves as a fulcrum for changing a posture of the head assembly when the head assembly moves from the first position to the second position.

2. The head unit according to claim 1, wherein
the head assembly includes
the thermal printer head, and
a head support plate that supports the thermal printer head, is arranged on an opposite side of the thermal head to the conveyance path, in the second direction, and is movable integrally with the thermal printer head,
the fulcrum portion includes a biasing member that biases the head support plate toward the conveyance path,
the head support plate includes a first overhanging portion that overhangs in the first direction up to a position where the overhanging portion does not overlap the thermal printer head at the first position,
the positioning portion positions the head assembly at the first position by coming into contact with the head support plate,
the guide portion guides movement of the head assembly by coming into contact with the head support plate and guiding movement of the head support plate,
the biasing member is in contact with the head support plate when the head assembly moves from the first position to the second position, and
a posture of the head assembly is changed, with the biasing member as a fulcrum, by the first overhanging portion being pushed in a direction away from the conveyance path in the second direction.

3. The head unit according to claim 2, wherein
the frame includes
a main body plate arranged on an opposite side of the thermal head 41h to the conveyance path, in the second direction, and
a pair of side plates arranged apart from each other in a third direction along a width direction of the recording medium and protruding from the main body plate in the second direction, and
the positioning portion and the guide portion are formed in the pair of side plates respectively.

4. The head unit according to claim 2, further comprising a head cover connected to the frame and swingable around a rotation axis extending in the third direction along the width direction of the recording medium, the head cover including
a main body plate for covering the thermal printer head, and
a first protrusion protruding in a plate thickness direction of the thermal printer head, in a state where the main body plate covers the thermal printer head, wherein
the head support plate further includes a second overhanging portion that overhangs on a side opposite to a side on which the first overhanging portion overhangs in the first direction,
the second overhanging portion contacts the first protrusion, in a state where the head assembly is positioned at the first position and the main body plate covers the thermal printer head, and
a gap is formed between the first protrusion and the second overhanging portion, in a state where the head support plate is in contact with the guide portion.

5. The head unit according to claim 4, wherein
the head cover further includes a second protrusion that is arranged at a position farther away than the first protrusion and protrudes from the rotation axis in a same direction as the first protrusion, and
the second protrusion is configured to be contactable with the head support plate at a position closer to the rotation axis than a position at which the fulcrum portion and the head support plate are in contact with each other in the first direction.

6. The head unit according to claim 2, wherein
the fulcrum portion is arranged rearward of the guide portion in the first direction.

7. The head unit according to claim 2, wherein
the thermal printer head includes a connection portion connectable to a flexible substrate, and
the connecting portion is arranged rearward of the fulcrum portion in the first direction.

8. The head unit according to claim 2, wherein the head support plate includes a second overhanging portion that overhangs on a side opposite to a side on which the first overhanging portion overhangs in the first direction, and
the frame has a locking portion to which the second overhanging portion is locked.
